(19) United States
(12) Patent Application Publication
(10) Pub. No.: US 2014/0205697 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/954,094

(22) Filed: Jul. 30, 2013

(30) Foreign Application Priority Data
Jan. 24, 2013 (TW) 102102731

(51) Int. Cl. B30B 3/00; B29D 99/00

(52) U.S. Cl. CPC B30B 3/005; B29D 99/0032
USPC 425/117; 425/471; 264/212

(57) ABSTRACT

A molding roller includes a cylindrical main body and a seamless ring-shaped molding film. The main body has a circumferential surface. The molding film is directly formed on the circumferential surface. The molding film has a molding surface opposite to the main body. The molding surface has a number of molding patterns. The molding film is made of polymer material, and the polymer material is obtained through the polymerization of polydimethylsiloxane and hard chain additive. The invention further relates to an apparatus and provides a method for manufacturing the molding roller.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. However, the molding patterns are directly formed on the circumferential surface, therefore, when the molding patterns are destroyed, the metallic roller needs to be discarded. This results a relatively high cost.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

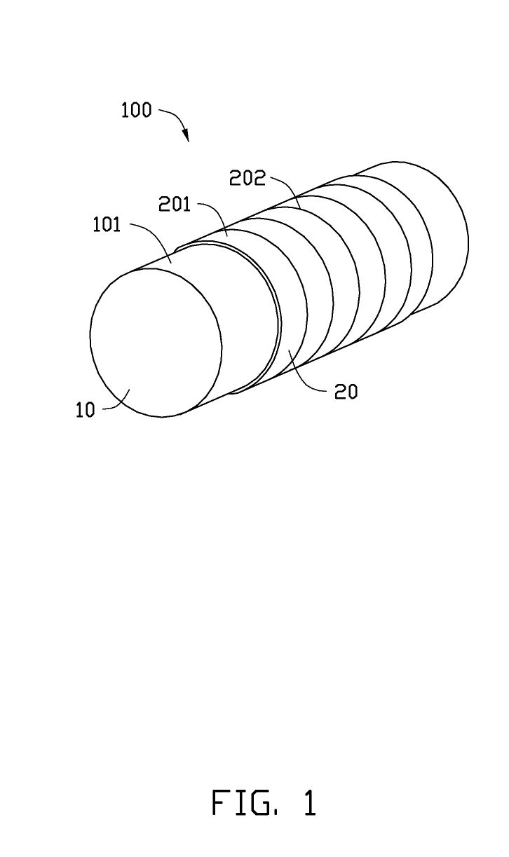

FIG. 1 illustrates a molding roller 100 in accordance to a first exemplary embodiment. The molding roller 100 includes a cylindrical main body 10 and a seamless ring-shaped molding film 20. The main body 10 includes a circumferential surface 101, and can be made of stainless steel or other metals.

The molding film 20 is directly coated on the circumferential surface 101. The molding film 20 includes a molding surface 201 opposite to the main body 10. The molding surface 201 includes a number of molding patterns 202. In the first embodiment, the molding patterns 202 are micro striped grooves. In other embodiments, the molding patterns 202 can be micro-dots or micro-protrusions.

The molding film 20 is made of flexible polymer material. The flexible polymer material is obtained through polymerization of polydimethylsiloxane and hard chain additive. In the first embodiment, the hard chain additive is poly(siloxane-urethane) (PSiU) which is obtained through polymerization of 4,4′-diphenylmethane diisocyanate (MDI) and 1,4-butanediol (1,4-BD). Because the polymer material is easily separated from the optical films, the molding film 20 is easily separated from optical films, and the quality of the optical films can be greatly improved.

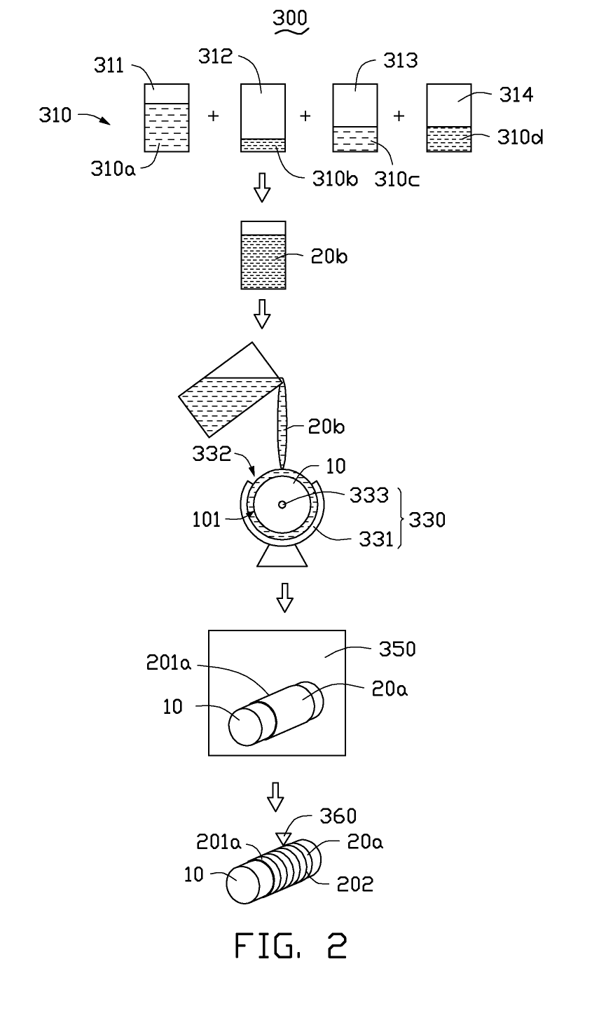

FIG. 2 illustrates an apparatus 300 for manufacturing the molding roller 100, according to a second exemplary embodiment. The apparatus 300 includes a mixing assembly 310, a coating device 330, a curing device 350, and a processing device 360.

The mixing assembly 310 is used for mixing the PDMS 310a and the hard chain additive 310b according the hardness requirement, and thus the PDMS 310a is polymerized with the hard chain additive 310b to obtain the molding film material 20b. The hard chain additive 310b is PSiU, and is obtained through the polymerization of MDI and 1,4-BD.

The mixing assembly 310 includes a first container 311, a second container 312, a third container 313, and a fourth container 314. The first container 311 receives the PDMS 310a. The second container 312 receives the hard chain additive 310b. The third container 313 receives a solvent 310c consisting of N,N-dimethylformamide (DMF) and tetrahydrofuran (THF). The fourth container 314 receives a catalyst 310d. In the second embodiment, the catalyst 310d is di-n-butyltin dilaurate (T-12), and the weight of the catalyst 310d is about 0.02% of the sum of the weight of the PDMS 310a and the weight of the hard chain additive 310b.

In particular, the PDMS 310a and the hard chain additive 310b are mixed according the hardness requirement to obtain a mixed solute, the mixed solute is poured into the solvent 310c, the mixed solute and the solvent are stirred at a predetermined temperature (such as 55° C.) for a predetermined period (such as 2 hours), and thus the mixed solute is absolutely dissolved in the solvent 310c to obtain a reaction liquid. Then the catalyst 310d is added into the reaction liquid, and the catalyst 310d promotes the polymerization of the PDMS and the hard chain additive, and thus the molding film material is obtained. In the second embodiment, the first container 311, the second container 312, the third container 313, and the fourth container 314 are measuring glasses.

The coating device 330 is used for coating the molding film material 20b to the circumferential surface 101 of the main body 10. The molding film material 20b is cooled to form a seamless ring-shaped preprocessed molding film 20a. The preprocessed molding film 20a and the main body 10 cooperatively form a preprocessed molding roller 100a. The preprocessed molding roller 100a has a preprocessed molding surface 201a opposite to the main body 10. In the second embodiment, the coating device 330 includes a molding chamber 331 and a rotating shaft 333. The shape of the molding chamber 331 substantially fits the shape of the molding roller 100. The rotating shaft 333 is used for rotating the main body 10. The main body 10 is received in the molding chamber 331, and the molding chamber 331 has an opening 332. The molding film material 20b is poured into the molding chamber 331 through the opening 332, and the main body 10 is rotated, and thus the molding film material 20b is uniformly coated on the circumferential surface 101 of the main body 10.

The curing device 350 is used for curing the molding film material 20b on the main body 10 to form a seamless ring-shaped preprocessed molding film 20a. The preprocessed molding film 20a has a preprocessed molding surface 201a opposite to the main body 10. In the second embodiment, the curing device 350 is an oven, the main body 10 with the molding film material 20b is received in the oven, and the curing temperature is about 65° C.

The processing device 360 is used for forming the molding patterns 202 on the preprocessed molding surface 201a to obtain the molding film 20. The molding film 20 and the main body 10 cooperatively form the molding roller 100. The processing device 360 can include a diamond knife or a laser knife.

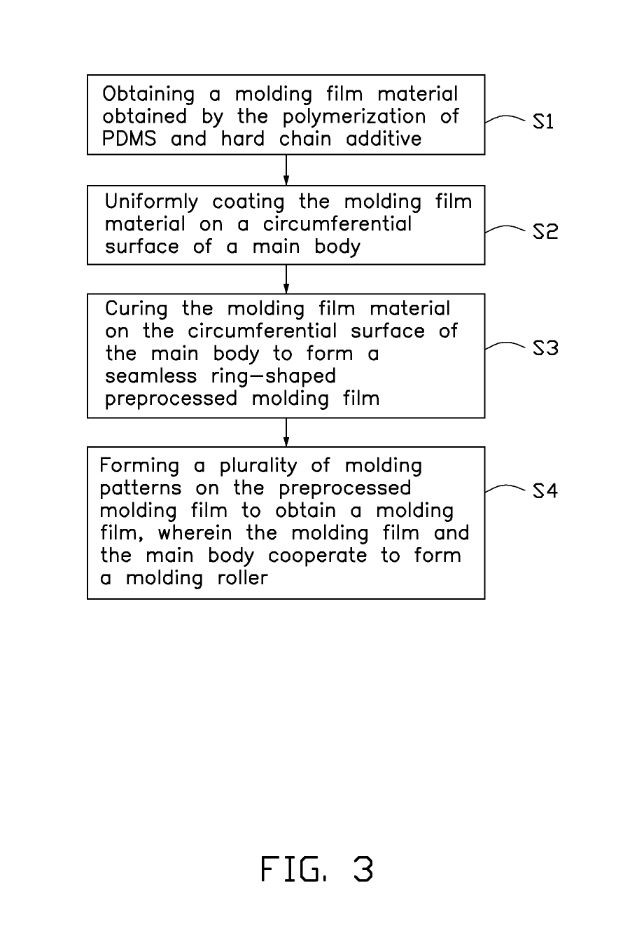

FIG. 3 illustrates a method for manufacturing the molding roller 100 using the apparatus 300 according to a third exemplary embodiment. The method includes the following steps.

In step S1, the PDMS 310a and the hard chain additive 310b are mixed using the mixing assembly 300 according to the hardness requirement, then the PDMS 310a is polymerized with the hard chain additive 310b to obtain the molding film material 20b.

In step S2, the molding film material 20b is uniformly coated on the circumferential surface 101 of the main body 10 using the coating device 320.

In step S3, the curing device 330 cures the molding film material 20b on the circumferential surface 101 of the main body 10, and thus to obtain a seamless ring-shaped preprocessed molding film 20a. In the third embodiment, the curing device 330 is an oven, the main body 10 with the molding film material 20b is received in the oven, and the curing temperature is about 65° C.

In step S4, a number of molding patterns 202 are formed on the preprocessed molding surface 20a using the processing device 360, and thus the molding film 20 is obtained. The molding film 20 and the main body 10 cooperatively form the molding roller 100.

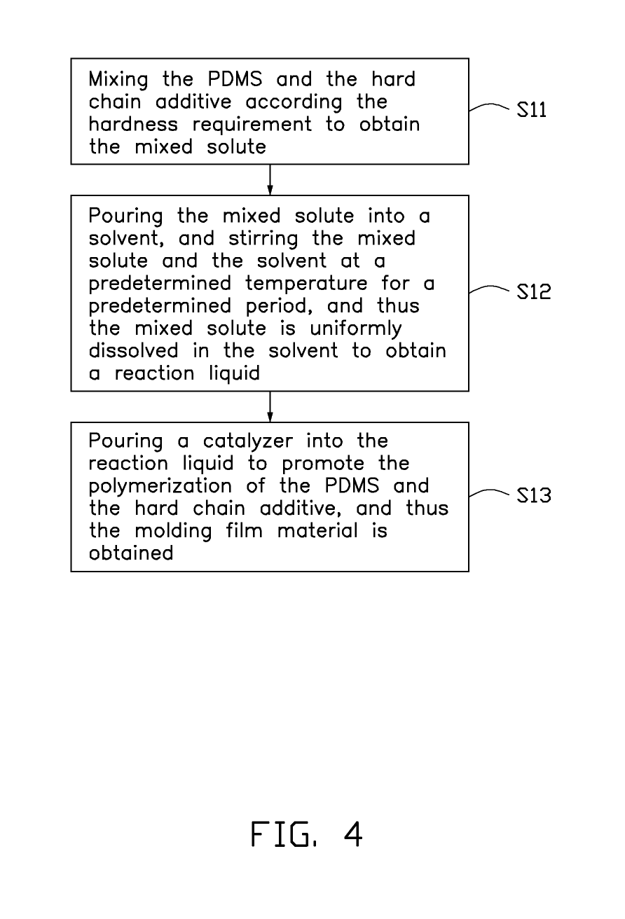

FIG. 4 illustrates that the step S1 further includes the following sub-steps.

In step S11, the PDMS 310a and the hard chain additive 310b are mixed according the hardness requirement to obtain the mixed solute. In the third embodiment, the hard chain additive 310b is PSiU obtained through the polymerization of MDI and 1,4-BD.

In step S12, the mixed solute is applied to the solvent 310c consisting of DMF and THF, then the mixed solute and the solvent 310 are stirred at the predetermined temperature (such as 55° C.) for the predetermined period (such as 2 hours), and thus the mixed solute is uniformly dissolved in the solvent 310 to obtain a reaction liquid.

In step S13, the catalyst (such as T-12) 310d is poured into the reaction liquid to promote the polymerization of the PDMS 310a and the hard chain additive 310b, and thus the molding film material 20b is obtained.

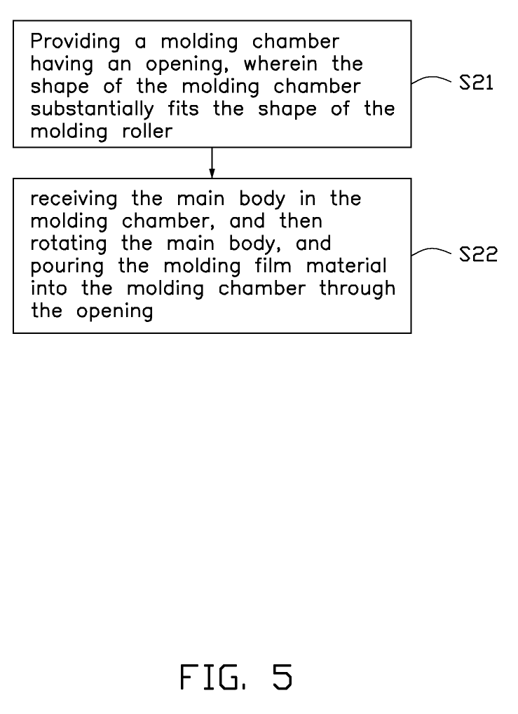

FIG. 5 illustrates that the step S2 further includes the following sub-steps.

In step S21, a molding chamber 331 is provided and has an opening 332, and the shape of the molding chamber 331 substantially fits the shape of the molding roller 100.

In step S22, the main body 10 is received in the molding chamber 331, and then the main body 10 is rotated, and the molding film material 20b is poured into the molding chamber 331 through the opening 332, and thus the molding film material 20b is uniformly coated on the circumferential surface 101 of the main body 10.

By employing the apparatus 300 and the above described method, the molding patterns 202 are formed on the molding film 20, therefore, when the molding patterns 202 are destroyed, the molding film 20 can be removed from the main body 10, and another new molding film 20 can be formed on the main body 10 to form a new molding roller 100. Therefore, the main body 10 can be used more times, and the molding roller 100 has a relatively low cost.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a circumferential surface; and
a seamless ring-shaped molding film directly formed on the circumferential surface, the molding film having a molding surface opposite to the main body, and the molding surface having a plurality of molding patterns;
wherein the molding film is made of polymer material, and the polymer material is obtained through polymerization of polydimethylsiloxane and hard chain additive.

2. The molding roller of claim 1, wherein the hard chain additive is poly(siloxane-urethane) obtained through the polymerization of 4,4′-diphenylmethane diisocyanate and 1,4-butanediol.

3. The molding roller of claim 1, wherein the main body is made of metal.

4. An apparatus for manufacturing a molding roller, comprising:
a mixing assembly configured for obtain a molding film material by polymerization of polydimethylsiloxane and hard chain additive;
a coating device for uniformly applying the molding film material on a circumferential surface of a main body, wherein the coating device comprises a molding chamber, the shape of the molding chamber substantially fits with the shape of the molding roller, the main body is received and is capable of rotating in the molding chamber, the molding chamber has an opening through which the molding film material is applied on the circumferential surface;
a curing device for curing the molding film material on the circumferential surface of the main body to form a seamless ring-shaped preprocessed molding film on the circumferential surface of the main body, wherein the main body with the molding film material is received in the curing device; and
a processing device configured for forming a plurality of molding patterns on the preprocessed molding film to obtain a molding film, the molding film and the main body cooperatively forming the molding roller.

5. The apparatus of claim 4, wherein the mixing assembly comprises a first container, a second container, a third container, and a fourth container, the first container receives the polydimethylsiloxane, the second container receives the hard chain additive, the third container receives a solvent, the fourth container receives a catalyst.

6. The apparatus of claim 5, wherein the hard chain additive is poly(siloxane-urethane) obtained through polymerization of 4,4′-diphenylmethane diisocyanate and 1,4-butanediol.

7. The apparatus of claim 6, wherein the solvent is consisted of N,N-dimethylformamide and tetrahydrofuran, the catalyst is di-n-butyltin dilaurate.

8. The apparatus of claim 6, wherein the processing device comprises a diamond knife or a laser knife.

9. The apparatus of claim 6, wherein the curing device comprises an oven.

10. A method for manufacturing a molding roller, comprising:
obtaining a molding film material by polymerization of polydimethylsiloxane and hard chain additive;
uniformly applying the molding film material on a circumferential surface of a main body;
curing the molding film material on the circumferential surface of the main body to form a seamless ring-shaped preprocessed molding film; and
forming a plurality of molding patterns on the preprocessed molding film to obtain a molding film, the molding film and the main body cooperatively forming the molding roller.

11. The method of claim 10, wherein the step of obtaining a molding film material by the polymerization of polydimethylsiloxane and hard chain additive of further comprises:
mixing the polydimethylsiloxane and the hard chain additive according the hardness requirement to obtain a mixed solute;
pouring the mixed solute into a solvent, and stirring the mixed solute and the solvent at a predetermined temperature for a predetermined period, and thus the mixed solute is uniformly dissolved in the solvent to obtain a reaction liquid; and
pouring a catalyst into the reaction liquid to promote the polymerization of the PDMS and the hard chain additive, and thus the molding film material is obtained.

12. The method of claim 10, wherein the step of uniformly coating the molding film material on a circumferential surface of a main body further comprises:
providing a molding chamber having an opening, and the shape of the molding chamber substantially fitting with the shape of the molding roller;
receiving the main body in the molding chamber, and then rotating the main body, and pouring the molding film material into the molding chamber through the opening.

13. The method of claim 10, wherein the hard chain additive is poly(siloxane-urethane) obtained through the polymerization of 4,4′-diphenylmethane diisocyanate and 1,4-butanediol.

14. The method of claim 13, wherein the solvent is consisted of N,N-dimethylformamide and tetrahydrofuran, the catalyst is di-n-butyltin dilaurate.

15. The method of claim 14, wherein the weight of the catalyst is about 0.02% of the sum of the weight of the polydimethylsiloxane and the weight of the hard chain additive.
